(19) United States
(12) Patent Application Publication
(10) Pub. No.: US 2015/0183131 A1
(43) Pub. Date: Jul. 2, 2015

(54) SEMICONDUCTOR WAFER DICING BLADE

(71) Applicants: Chee Seng Foong, Sg. Buloh (MY); Wen Shi Koh, Petaling Jaya (MY); Kai Yun Yow, Petaling Jaya (MY)

(72) Inventors: Chee Seng Foong, Sg. Buloh (MY); Wen Shi Koh, Petaling Jaya (MY); Kai Yun Yow, Petaling Jaya (MY)

(21) Appl. No.: 14/141,471

(22) Filed: Dec. 27, 2013

(51) Int. Cl. B28D 5/02; B24D 3/06; B24D 5/14

(52) U.S. Cl. CPC B28D 5/022; B24D 5/14; B24D 3/06

(57) ABSTRACT

A dicing blade suitable for cutting a semiconductor wafer has an edge of fine grit for polishing a top surface of the wafer and a protruding part of coarse grit for making an initial cut into the wafer. The blade reduces chipping of the top surface of the wafer and increases throughput by facilitating cutting and polishing in one operation. The blade can dice and polish comparatively thick wafers having narrow scribe lines in a single operation.

### BACKGROUND OF THE INVENTION

The present invention relates generally to cutting or dicing of semiconductor wafers and, more particularly, to a saw blade for cutting semiconductor wafers.

Semiconductor dies or integrated circuits are fabricated on wafers of silicon, for example, by a thin film formation technique, photolithography, impurity implantation technique, and so forth. After the integrated circuits are formed, the wafer is diced to cut or separate the individual circuits by cutting the wafer in both transverse and longitudinal directions along scribe lines. Dicing of a semiconductor wafer is usually done using a mechanical saw with a rotary dicing blade that can slice through a wafer mounted on a chuck table. While often referred to as “sawing,” the process generally uses an abrading process in which a circular blade composed of abrasive materials embedded in a binder matrix rotates at high speeds to grind away the wafer material. The cutting region of a dicing blade commonly consists of diamond grit embedded in a thin aluminium matrix, although other suitable materials exist. Blade thicknesses can vary but typically are between 15 and 140 microns. During the cutting process, cracks can develop in the wafer.

One known method for reducing the incidence of cracks employs a two-step process, partially cutting the wafer with a diamond blade to form grooves and then cutting through the remaining part of the wafer with a smaller-width resin blade. However, a two-step process reduces throughput.

Another undesirable effect that can take place during the cutting process is chipping of the upper and lower surfaces of the wafer. Chipping can occur when silicon particles loosen from the wafer between the rotating blade and the wafer being cut. In fact, one of the main defects that impacts integrated circuit assembly yield is “top side” (or upper surface) chipping of the dies, which occurs during the sawing (or cutting) process.

The occurrence of chipping can be reduced by operating at reduced dicing blade rotational speeds but this has the disadvantage of reducing throughput. One known method for reducing chipping is to use a dicing blade having an inner layer containing a first set of dicing particles and an outer layer containing a second set of dicing particles overlying the inner layer. The second set of dicing particles has a mean particle size that is smaller than a mean particle size of the first set and the inner layer extends beyond the outer layer to the outermost periphery of the blade. However, this blade design is not a practical solution for comparatively thick wafers with comparatively narrow scribe lines.

Thus, it would be advantageous to be able to cut or dice semiconductor wafers without chipping or cracking the dies and without reducing throughput.

### BRIEF DESCRIPTION OF THE DRAWINGS

The invention, together with objects and advantages thereof, may best be understood by reference to the following description of preferred embodiments together with the accompanying drawings in which:

FIGS. 1, 2 and 3 are simplified side sectional profiles of an example of a dicing blade performing a wafer cutting operation in accordance with the present invention; and

FIGS. 4 to 8 are side sectional profiles of a dicing blade in various stages of manufacture, in accordance with the present invention.

### DETAILED DESCRIPTION OF PREFERRED EMBODIMENTS

The detailed description set forth below in connection with the appended drawings is intended as a description of presently preferred embodiments of the invention, and is not intended to represent the only forms in which the present invention may be practised. It is to be understood that the same or equivalent functions may be accomplished by different embodiments that are intended to be encompassed within the spirit and scope of the invention. In the drawings, like numerals are used to indicate like elements throughout. Furthermore, terms “comprises,” “comprising,” or any other variation thereof, are intended to cover a non-exclusive inclusion, such that module, circuit, device components, structures and method steps that comprises a list of elements or steps does not include only those elements but may include other elements or steps not expressly listed or inherent to such module, circuit, device components or steps. An element or step proceeded by “comprises . . . a” does not, without more constraints, preclude the existence of additional identical elements or steps that comprises the element or step.

In one embodiment, the present invention provides a dicing blade having a blade edge comprising a first set of dicing particles and a stepped protuberance extending beyond the blade edge and comprising a second set of dicing particles having a mean particle size that is larger than a mean particle size of the first set of dicing particles.

In another embodiment, the present invention provides a dicing blade comprising two disks each having inner faces that are bonded together, each disk having an annular recess formed in its inner face. The annular recesses contain a first layer of dicing particles that extend a first distance beyond the periphery of the disk, and a second layer of dicing particles overlaying the first layer and extending a second distance beyond the periphery of the disk, where the second distance is greater than the first distance. A mean size of the dicing particles of the second layer is larger than a mean size of the dicing particles of the first layer.

In yet another embodiment, the present invention provides a method of manufacturing a dicing blade, comprising: (a) forming an annular recess in an inner face of a disk, (b) forming a first layer of dicing particles in the recess, (c) forming a second layer of dicing particles over the first layer and over a peripheral region of the disk, where a mean size of the dicing particles forming the second layer is large than a mean size of the dicing particles forming the first layer, (d) removing a part of the disk that includes the peripheral region of the disk to expose part of the first and second layers, and (e) bonding together the inner faces of the two disks formed in accordance with steps (a) to (d).

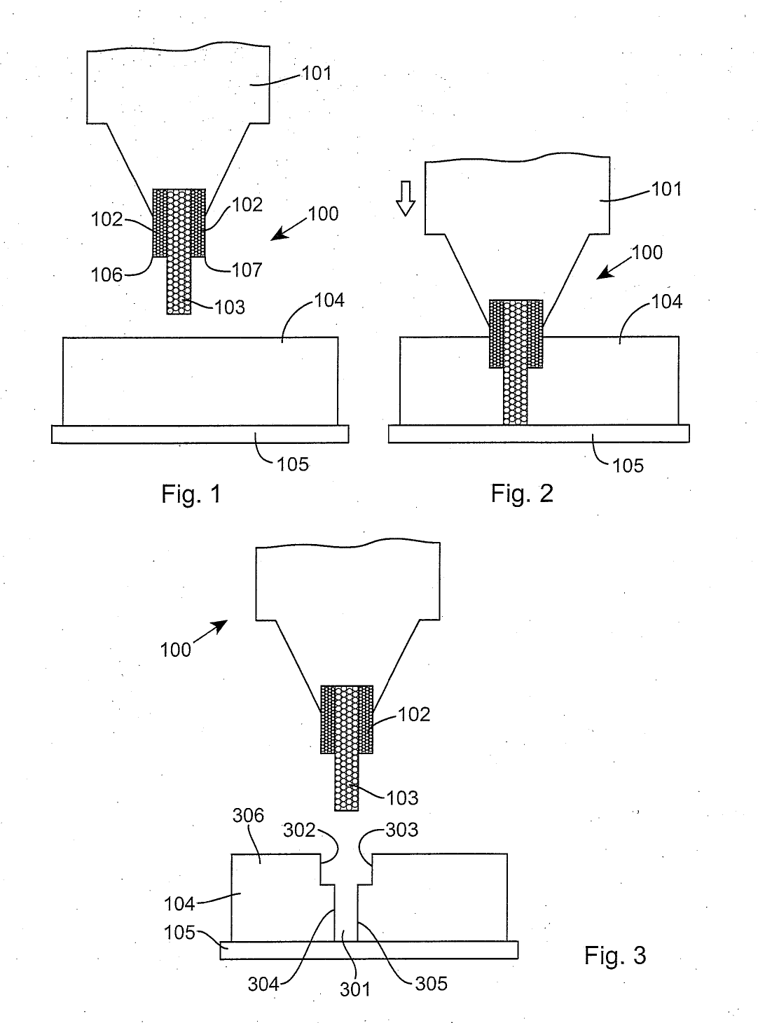

Referring now to FIG. 1, a dicing blade 100 may be formed in a hub 101 mounted on a rotatable spindle (not shown) and driven up to angular speeds of typically between 30,000 and 60,000 revolutions per minute (RPM). The dicing blade 100 has a blade edge 102 preferably formed of fine grit dicing particles. A typical, mean particle size for the fine grit is between 1.5 and 1.8 microns but other sizes are possible. The blade 100 also includes a protuberance 103 that extends beyond the blade edge 102. The protuberance 103 preferably comprises coarse grit dicing particles. A typical mean particle size for the coarse grit is between 2 and 4 microns. The thicknesses of the blade edge 102 and protuberance 103 are sufficient to withstand a desired blade life based on wear rate. The fine grit and coarse grit dicing particles may be diamond particles or synthetic diamond particles, for example. In one embodiment, the blade edge 102 has a lower particle density than the protuberance 103.

In one embodiment, the protuberance 103 is rectangular in profile and is stepped, which provides a sharp, step decrease in blade thickness. In an alternative embodiment, the transition between the thicknesses is provided by a bevelled edge. The corners of the protuberance 103 are rounded, and the length of the protuberance 103 is comparable with a desired total cut depth into a silicon wafer work piece 104 to be diced. In one example, the length of the protuberance 103 is two thirds of the silicon wafer work piece thickness plus 23 per cent of the thickness of adhesive dicing tape 105 to which the silicon wafer work piece 104 may be affixed. The thickness of the protuberance 103 is dictated by the width of a scribe line (not shown) in the silicon wafer work piece 104 and also by the wafer thickness for a step cut. A wider scribe width and a thicker wafer will dictate a greater thickness of the protuberance 103. A comparatively thick protuberance 103 can result in good stability during cutting. For example, for a 60 micron scribe line width, the thickness of the protuberance 103 is in a range 15-20 microns. Other widths of the protuberance 103 are possible, however.

In one embodiment, the widths of shoulders 106, 107 of the blade edge 102 located on either side of the protuberance 103 are equal. In one example, the width of the shoulders 106, 107 is 25 per cent of the thickness of the protuberance 103. The thickness of the blade 100 is, to some extent, dictated by scribe line width and work piece 104 thickness. In one example, the length of the blade edge 102 (that is from the point at which the blade edge 102 extends from the hub 101 to the step change in thickness at the start of the protuberance 103) is one third of the silicon wafer work piece 104 thickness.

With reference now to FIG. 2, during a dicing operation, once the blade 100 has been aligned with a scribe line on the silicon wafer work piece 104, the blade 100 is rotated on the spindle and gradually lowered towards the work piece 104 in the direction of the arrow. The angular speed of the blade 100 is typically 30,000-60,000 RPM. Typically, the silicon wafer work piece 104, mounted on the adhesive tape 105, is secured on a chuck table (not shown) that may be moved laterally so that the work piece 104 is brought into contact with the blade 100 as it descends. The chuck table typically is moved at a speed of about 100 mm per second.

Referring now to FIG. 3, the protuberance 103 with its coarse dicing particles severs the entire silicon wafer work piece 104 to form a trench 301. The blade edge 102 with its fine particles polishes and dresses upper edges 302, 303 of the cut trench 301. The blade 100 then exits one fully cut scribe line of the work piece 104. The chuck table may then index to the next scribe line by one pitch and the blade 100 is lowered again to perform a subsequent cutting operation as shown in FIG. 2. After dicing the entire silicon wafer work piece 104, the blade 100 is retracted away from the diced wafer. The initial cut by the protuberance 103 comprising the coarse dicing particles initially creates straight sidewalls 304, 305. As the blade 101 advances further into the work piece 104 the (thicker) blade edge 102 with its fine dicing particles begins to polish the upper edges 302, 303 of the sidewalls 304, 305 where all the critical interlayer dielectrics (ILD) are located. The sensitive ILD and circuitry layers located near the upper surface 306 of the silicon wafer work piece 104 are advantageously polished and dressed, thereby removing imperfections such as chipping, cracking and peeling. Thus, the work piece 104 is separated into dies by the coarse dicing particles of the protuberance 103 and the fine dicing particles of the blade edge 102 polish and remove blemishes and chipping from the top side of the dies. The protuberance 103 may also widen an upper portion of the trench 301 (see FIG. 3).

Advantageously, with the ability to remove blemishes and topside chipping, the saw process speed may be faster compared with known arrangements thereby resulting in high throughput. Furthermore, the blade 100 may achieve the same outcome as a two-step process (i.e., cut then polish) but using just a single blade in a single cutting operation, thereby achieving improved throughput. Advantageously, the step change in blade thickness permits, in one operation, the cutting and the upper surface polishing of comparatively thick wafers having comparatively narrow scribe lines.

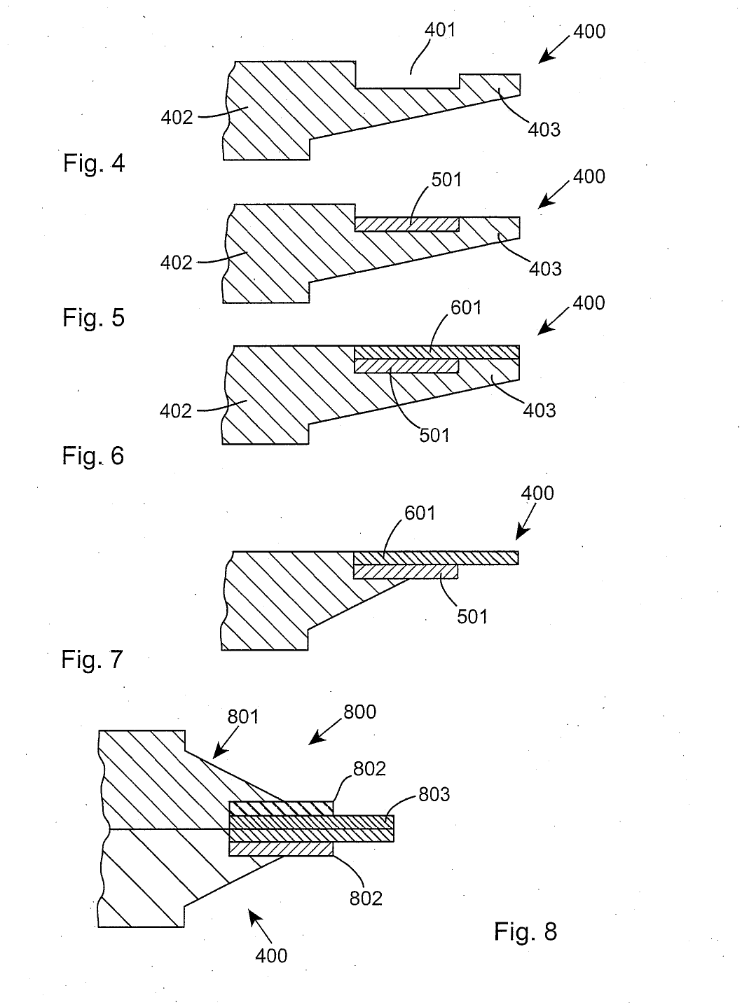

A method of manufacturing a dicing blade will now be described with reference to FIGS. 4-8. First and second identical halves of a hub are each precision machined into a disc shape from aluminum blanks. A part of just one hub half 400 is shown in FIGS. 4-7. An annular recess 401 (see FIG. 4) is made in an inner face of each hub half 400 by a machining process. The recess 401 is located between a central portion 402 and a peripheral portion 403 of the hub half 400.

Each hub half 400 then undergoes an electro-forming process in which nickel including fine dicing particles is electro-formed into the recess 401 to form a first layer 501 (see FIG. 5). The fine dicing particles preferably have a mean particle size of between 1.5 and 1.8 microns but other sizes are possible. The particles may be diamond or synthetic diamond particles, for example.

In a next step (see FIG. 6), again using an electro-forming process, a second layer 601 of nickel, this time including coarse dicing particles, is electro-formed on top of the first layer 501 and also over an inner face of the peripheral portion 403 of each hub of 400. The coarse dicing particles preferably have a mean size of between 2 and 4 microns but other sizes are possible. The particles may be diamond or synthetic diamond particles, for example. In one embodiment, the thickness of the second layer 601 is of the order of 25 microns. In a next step, exposed surfaces of the second layer 601 are polished in a conventional polishing process.

In a next step, (see FIG. 7) a part of each hub half 400, which includes the peripheral part 403, is etched away to expose portions of the first and second layers 501, 601. The exposed portions of the first and second layers 501, 601 then are polished. Each hub half 400 now comprises a stepped peripheral blade portion comprising a fine grit layer 501 and a coarse grit layer 601 extending beyond the fine grit layer 501.

In a next step, (see FIG. 8) a dicing blade 800 is formed by bonding together two hub halves 400, 801 each formed as described above with reference to FIGS. 4 to 7 and having the same dimensions. Bonding may be performed using a suitable adhesive. Hence, the dicing blade 800 having a blade edge 802 comprising fine dicing particles and a stepped protuberance 803 that extends beyond the blade edge 802 and which has a smaller thickness than the blade edge 802 and comprises coarse dicing particles, is formed. A final polishing process may be performed in order to finely hone the blade 800 to the desired dimensions to suit a particular silicon wafer cutting operation.

The description of the preferred embodiments of the present invention has been presented for purposes of illustration and description, but is not intended to be exhaustive or to limit the invention to the forms disclosed. It will be appreciated by those skilled in the art that changes could be made to the embodiments described above without departing from the broad inventive concept thereof. It is understood, therefore, that this invention is not limited to the particular embodiment disclosed, but covers modifications within the spirit and scope of the present invention as defined by the appended claims.

1. A dicing blade having a blade edge, comprising:
a first set of dicing particles; and
a stepped protuberance extending beyond the blade edge, wherein the stepped protuberance comprises a second set of dicing particles having a mean particle size that is larger than a mean particle size of the first set of dicing particles.

2. The dicing blade of claim 1, wherein the protuberance is rectangular in profile.

3. The dicing blade of claim 1, wherein the first set of dicing particles has a lower density than that of the second set of dicing particles.

4. The dicing blade of claim 1, wherein said dicing particles are diamond particles.

5. The dicing blade of claim 1, wherein dicing particles comprising the first set of dicing particles have a mean particle size of between 1.5 and 1.8 micron.

6. The dicing blade of claim 1, wherein dicing particles comprising the second set of dicing particles have a mean particle size of between 2 and 4 micron.

7. The dicing blade of claim 1, wherein the blade edge comprises at least one layer of nickel and fine grit dicing particles.

8. The dicing blade of claim 1, wherein the protuberance comprises at least one layer of nickel and coarse grit particles.

9. A dicing blade, comprising:
two disks each having inner faces that are bonded together, each disk having an annular recess formed in its inner face, said annular recess containing a first layer of dicing particles that extends a first distance beyond the periphery of the disk and a second layer of dicing particles overlaying the first layer and extending a second distance beyond the periphery of the disk,
wherein the second distance is greater than the first distance and wherein a mean size of the dicing particles comprising the second layer is larger than a mean size of the dicing particles comprising the first layer.

10. A method of manufacturing a dicing blade, comprising:
(a) forming an annular recess in an inner face of a disk;
(b) forming a first layer of dicing particles in said recess;
(c) forming a second layer of dicing particles over the first layer and a peripheral region of the disk wherein a mean size of the dicing particles comprising the second layer is larger than a mean size of the dicing particles comprising the first layer;
(d) removing a part of the disk which includes at least the peripheral region of the disk to expose at least a part of said first and second layers; and
(e) bonding together the inner faces of two disks formed in accordance with steps (a) to (d).

11. The method of claim 10, wherein the first layer of dicing particles and the second layer of dicing particles are formed by an electroforming process.

12. The method of claim 10, wherein removal of said part of the disk which includes at least the peripheral region of the disk is performed by an etching process.

13. The method of claim 10, wherein the dicing particles are diamond particles.

14. The method of claim 10, wherein dicing particles comprising the first set of dicing particles have a mean particle size of between 1.5 and 1.8 micron.

15. The method of claim 10, wherein dicing particles comprising the second set of dicing particles have a mean particle size of between 2 and 4 micron.

16. The method of claim 10, wherein said first and second layers comprise nickel and dicing particles.

17. The method of claim 10, wherein said dicing blade is used to dice semiconductor wafers.
